(19) United States
(12) Patent Application Publication
(10) Pub. No.: US 2024/0325893 A1
(43) Pub. Date: Oct. 3, 2024

(54) Virtual Scene Synchronization and Display

(71) Applicant: Tencent Technology (Shenzhen) Company Limited, Shenzhen (CN)

(72) Inventors: Ruijie Qin, Shenzhen (CN); Peixin Huang, Shenzhen (CN)

(21) Appl. No.: 18/739,499

(22) Filed: Jun. 11, 2024

Related U.S. Application Data
(63) Continuation of application No. PCT/CN2023/088688, filed on Apr. 17, 2023.

(30) Foreign Application Priority Data
Jun. 24, 2022 (CN) 202210730440.7

(51) Int. Cl. A63F 13/52; A63F 13/5372; A63F 13/55; A63F 13/60

(52) U.S. Cl. CPC A63F 13/52; A63F 13/5372; A63F 13/55; A63F 13/60

(57) ABSTRACT

A virtual scene synchronization method, a virtual scene display method, an apparatus, and a device are provided, which belong to the field of computer technologies. The method includes: receiving a midway joining request that is for a virtual scene and that is transmitted by a first terminal; transmitting data of a plurality of scene image frames of the virtual scene to the first terminal; in response to the first terminal running scene progress of the virtual scene to target progress, transmitting an object loading instruction carrying an object identifier to the first terminal and at least one second terminal to enable the first terminal and the at least one second terminal to load a target virtual object in the virtual scene. The above solutions can guarantee consistency of a virtual scene displayed at each terminal, and improve flexibility in participating in a virtual game.

### RELATED APPLICATION

This application is a continuation of and claims priority to PCT Application PCT/CN2023/088688, filed Apr. 17, 2023, which in turn claims priority to Chinese Patent Application No. 202210730440.7, filed on Jun. 24, 2022, each entitled “VIRTUAL SCENE SYNCHRONIZATION METHOD, VIRTUAL SCENE DISPLAY METHOD, APPARATUS, AND DEVICE”, and each of which is incorporated herein by reference in its entirety.

### FIELD OF THE TECHNOLOGY

This application relates to the field of computer technologies, and in particular to a virtual scene synchronization method, a virtual scene display method, an apparatus, and a device.

### BACKGROUND OF THE DISCLOSURE

With development of computer technologies, network games are increasing. How to keep various clients of a network game synchronized is a problem that needs to be resolved.

Currently, game synchronization may be performed in a form of frame synchronization. The frame synchronization is a network game synchronization method, where a server forwards an obtained operation instruction sequence of a plurality of clients to the respective clients, and the clients execute game logic based on the received operation instruction sequence to render scene image frames of a virtual scene, so as to achieve synchronized display of the scene image frames of the virtual scene by the respective clients.

However, the above solution is directed to synchronization between clients corresponding to virtual objects already present in the virtual scene, and does not enable virtual objects outside the virtual scene to join the virtual scene and keep the clients synchronized.

### SUMMARY

Aspects of this application provide a virtual scene synchronization method, a virtual scene display method, an apparatus, and a device, which can synchronize a terminal of a virtual object joined midway with a terminal of an existing virtual object, and promote more virtual objects to join a virtual scene. This improves participation. One technical solution provided herein is as follows:

In one aspect, a virtual scene synchronization method is provided. The method includes the following operations:
receiving, by a server, a midway joining request that is for a virtual scene and that is transmitted by a first terminal, the midway joining request carrying an object identifier of a target virtual object, the target virtual object being a virtual object controlled by the first terminal, and the virtual scene comprising a virtual object controlled by at least one second terminal;
transmitting, by the server, data of a plurality of scene image frames of the virtual scene to the first terminal, the data of the plurality of scene image frames being used to run scene progress of the virtual scene from initial progress to target progress, and the target progress being scene progress at which the virtual scene is currently located; and
in response to the first terminal running the scene progress of the virtual scene to the target progress, transmitting, by the server, an object loading instruction carrying the object identifier to the first terminal and the at least one second terminal to enable the first terminal and the at least one second terminal to load the target virtual object in the virtual scene.

In another aspect, a virtual scene display method is provided. The method includes the following operations.
obtaining, by a first terminal, data of a plurality of scene image frames of a virtual scene in response to a midway joining operation on the virtual scene, the midway joining operation indicating to join a target virtual object to the virtual scene;
running, by the first terminal based on the data of the plurality of scene image frames, scene progress of the virtual scene from initial progress to target progress, the target progress being scene progress at which the virtual scene is currently located; and
loading, by the first terminal, the target virtual object in the virtual scene.

In another aspect, a virtual scene synchronization apparatus is provided, and is disposed in a server. The apparatus includes:
a receiving module, configured to receive a midway joining request that is for a virtual scene and that is transmitted by a first terminal, the midway joining request carrying an object identifier of a target virtual object, the target virtual object being a virtual object controlled by the first terminal, and the virtual scene including a virtual object controlled by at least one second terminal; and
a transmitting module, configured to transmit data of a plurality of scene image frames of the virtual scene to the first terminal, the data of the plurality of scene image frames being used to run scene progress of the virtual scene from initial progress to target progress, and the target progress being scene progress at which the virtual scene is currently located,
the transmitting module being further configured to: in response to the first terminal running the scene progress of the virtual scene to the target progress, transmit an object loading instruction carrying the object identifier to the first terminal and the at least one second terminal to enable the first terminal and the at least one second terminal to load the target virtual object in the virtual scene.

In another aspect, a virtual scene display apparatus is provided, and is disposed in a first terminal. The apparatus includes:
an obtaining module, configured to obtain data of a plurality of scene image frames of a virtual scene in response to a midway joining operation on the virtual scene, the midway joining operation indicating to join a target virtual object to the virtual scene;
a running module, configured to run, based on the data of the plurality of scene image frames, scene progress of the virtual scene from initial progress to target progress, the target progress being scene progress at which the virtual scene is currently located; and
a loading module, configured to load the target virtual object in the virtual scene.

In another aspect, a computer device is provided, the computer device including a processor and a memory, the memory being configured to store at least one segment of computer program, and the at least one segment of computer program being loaded by the processor and performing the virtual scene synchronization method in aspects of this application, or the at least one segment of computer program being loaded by the processor and performing the virtual scene display method in aspects of this application.

In another aspect, a computer-readable storage medium is provided, the computer-readable storage medium having at least one segment of computer program stored therein, and the at least one segment of computer program being loaded by a processor and performing the virtual scene synchronization method in aspects of this application, or the at least one segment of computer program being loaded by a processor and performing the virtual scene display method in aspects of this application.

In another aspect, a computer program product is provided, when performed by a processor, the computer program product implementing the virtual scene synchronization method in aspects of this application, or when performed by a processor, the computer program product implementing the virtual scene display method in aspects of this application.

An aspect of this application provides a virtual scene synchronization solution. When a target virtual object controlled by a first terminal requests to join a virtual scene, data of a scene image frame is returned to the first terminal in a process in which scene progress of the virtual scene is run from initial progress to target progress, so that the first terminal can perform fast frame chasing based on the obtained data. In this way, the first terminal can run the scene progress of the virtual scene from the initial progress to the target progress. When the virtual scene of the first terminal is run to the target progress, an object loading instruction carrying an object identifier is transmitted to the first terminal and at least one second terminal at which a virtual object in the virtual scene is located, so that each terminal can load the target virtual object in the virtual scene at the target progress. This realizes synchronous display of the virtual scene on each terminal, makes an occasion for the target virtual object to join the virtual scene unrestricted, ensures consistency of displaying the virtual scene on each terminal no matter when the virtual object requests to join the virtual scene, and improves flexibility of participating in the virtual scene.

### BRIEF DESCRIPTION OF THE DRAWINGS

FIG. 1 is an implementation environment of a virtual scene synchronization method according to an illustrative aspect of this application.

FIG. 2 is a flowchart of a virtual scene synchronization method according to an illustrative aspect of this application.

FIG. 3 is a flowchart of a virtual scene display method according to an illustrative aspect of this application.

FIG. 4 is an interaction flowchart of another virtual scene synchronization method according to an illustrative aspect of this application.

FIG. 5 is a schematic diagram of a first virtual scene according to an illustrative aspect of this application.

FIG. 6 is a flowchart of an interaction of a target virtual object joining a virtual scene according to an illustrative aspect of this application.

FIG. 7 is a flowchart of an interaction of a target virtual object exiting a virtual scene according to an illustrative aspect of this application.

FIG. 8 is a schematic diagram of a structure of a virtual scene synchronization apparatus according to an illustrative aspect of this application.

FIG. 9 is a schematic diagram of a structure of another virtual scene synchronization apparatus according to an illustrative aspect of this application.

FIG. 10 is a schematic diagram of a structure of a virtual scene display apparatus according to an illustrative aspect of this application.

FIG. 11 is a schematic diagram of a structure of another virtual scene display apparatus according to an illustrative aspect of this application.

FIG. 12 is a schematic diagram of a structure of a terminal according to an illustrative aspect of this application.

FIG. 13 is a schematic diagram of a structure of a server according to an illustrative aspect of this application.

### DETAILED DESCRIPTION

To make the objectives, technical solutions, and advantages of this application clearer, the following further describes implementations of this application in detail with reference to the accompanying drawings.

In this application, the terms “first”, “second”, and the like are used to distinguish between identical or similar items having substantially the same role and function. There are no logical or temporal dependencies between “first”, “second”, “n^{th}”, and there in no limitation on a quantity and an execution order.

In this application, the term “at least one” means one or more, and “a plurality of” means two or more.

Information (including but not limited to user equipment information, user personal information, and the like), data (including but not limited to data for analysis, stored data, presented data, and the like), and a signal that are related to this application are authorized by a user or fully authorized by various parties, and collection, use, and processing of relevant data is required to comply with relevant laws and regulations and standards of relevant countries and regions. For example, data of scene image frames involved in this application is obtained under full authorization.

Hereinafter, terms involved in this application are explained for ease of understanding.

Frame synchronization is a network game synchronization method. A server separately forwards an obtained sequence of operation instructions triggered by a plurality of terminals to the plurality of terminals, and the plurality of terminals separately perform game logic based on the received sequence of operation instructions to render a virtual scene to achieve synchronization between the plurality of terminals.

Fast frame chasing is a manner of performing game logic in frame synchronization. For a virtual object joining a virtual scene midway, based on a sequence of operation instructions triggered in the virtual scene, the game logic is rapidly performed in time sequence, and then the virtual scene is rendered, so that game progress of a terminal manipulating the virtual object coincides with game scene progress of another terminal displaying the virtual scene.

A virtual object indicates a movable object in a virtual scene. The movable object may be a virtual person, a virtual animal, a cartoon person, or the like, for example, a character, an animal, a plant, an oil barrel, a wall, or a rock that is displayed in the virtual scene. The virtual object may be a virtual image representing a user in the virtual scene. A plurality of virtual objects may be included in the virtual scene, and each virtual object has a shape and a volume in the virtual scene, and occupies a portion of space in the virtual scene. The virtual object in aspects of this application is used to represent a virtual image of a user.

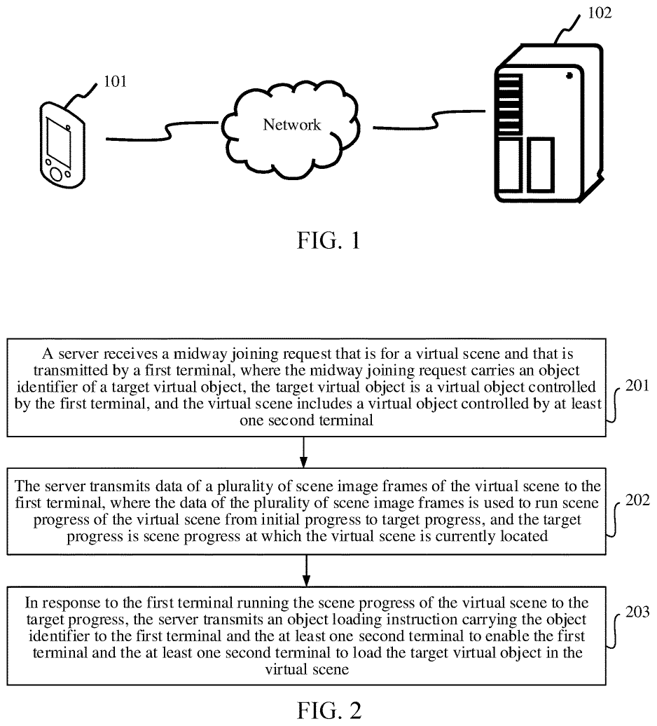

The virtual scene synchronization method provided by the aspects of the application can be performed by a computer device. In some aspects, the computer device is a terminal or a server. Hereinafter, an implementation environment of the virtual scene synchronization method provided by the aspects of this application is described by taking a computer device as a server as an example. FIG. 1 is a schematic diagram of an implementation environment of a virtual scene synchronization method according to an aspect of this application. Refer to FIG. 1. The implementation environment includes a terminal 101 and a server 102. The terminal 101 and the server 102 can be directly or indirectly connected in a wired or wireless communication manner. This is not limited in this application.

In some aspects, the terminal 101 is a smartphone, a tablet computer, a laptop computer, a desktop computer, a smart box, a smart watch, a smart voice interactive device, a smart appliance, an in-vehicle terminal, or the like, but is not limited thereto. An application is installed and run in the terminal 101. The application supports a virtual game. The virtual game may include one or more virtual scenes. When the virtual game includes one virtual scene, joining the virtual scene midway indicates to request to join the virtual game and join the virtual scene from outside the virtual game; or request to join the virtual scene when being in the virtual game, but not in the virtual scene. When the virtual game includes a plurality of virtual scenes, joining the virtual scene midway indicates to request to join the virtual game from outside the virtual game and join a virtual scene; or request to join a virtual scene when being in the virtual game but not in the virtual scene; or request to join one virtual scene from another virtual scene in the virtual game. The application may be any one of a first-person shooting game (FPS), a third-person shooting game, a multilayer online battle arena game (MOBA), a virtual reality application, a three-dimensional map program, or a multiplayer gunfight survival game. The terminal 101 is a terminal used by a user, on which a user account is registered. The user uses the terminal 101 to manipulate a virtual object located in the virtual scene for activities including, but not limited to, at least one of adjusting a body posture, crawling, walking, running, riding, jumping, driving, picking, shooting, attacking, or throwing. For example, the virtual object is a virtual person, like a simulation character or a cartoon character.

It will be appreciated by those skilled in the art that there may be more or less terminals described above. For example, there may be only one terminal, or there may be tens or hundreds of terminals, or more terminals. A quantity and a device type of terminals are not limited in the aspects of this application.

In some aspects, the server 102 is a stand-alone physical server, or can be a server cluster or distributed system including a plurality of physical servers, or can be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The server 102 is configured to provide a background service for an application supporting a virtual scene. In some aspects, the server 102 undertakes primary computational work, and the terminal 101 undertakes secondary computational work. Alternatively, the server 102 undertakes secondary computational work, and the terminal 101 undertakes primary computational work. Alternatively, a distributed computing architecture is employed between the server 102 and the terminal 101 for coordinated computing.

FIG. 2 is a flowchart of a virtual scene synchronization method according to an aspect of this application. FIG. 2 is illustrated by taking execution by a server as an example in an aspect of this application. The virtual scene synchronization method includes the following operations.

201: A server receives a midway joining request that is for a virtual scene and that is transmitted by a first terminal, where the midway joining request carries an object identifier of a target virtual object, the target virtual object is a virtual object controlled by the first terminal, and the virtual scene includes a virtual object controlled by at least one second terminal.

In an aspect of this application, the server is the server 102 of FIG. 1. The first terminal is the terminal 101 shown in FIG. 1, on which a user account is registered. The target virtual object can be manipulated through the user account to join the virtual scene. The first terminal transmits the midway joining request for the virtual scene to the server. The midway joining request carries the object identifier of the target virtual object and a scene identifier of the virtual scene. The server can determine, by resolving the midway joining request, that the target virtual object requests to join the virtual scene. Data synchronization is performed on the virtual scene in a frame synchronization manner. In other words, the server can obtain a sequence of operation instructions triggered by a plurality of terminals associated with the virtual scene, the server then synchronizes the obtained sequence of operation instructions triggered by the plurality of terminals to the plurality of terminals, and the plurality of terminals perform operation logic based on the received sequence of operation instructions to render the virtual scene to achieve display synchronization of the virtual scene on the plurality of terminals. The plurality of terminals include at least one second terminal, which is a terminal for manipulating a virtual object in a virtual scene. In addition to the at least one second terminal, the plurality of terminals may include another terminal. A virtual object controlled by the another terminal has entered the virtual scene, and the virtual object controlled by the another terminal is not in the virtual scene at a current moment.

202: The server transmits data of a plurality of scene image frames of the virtual scene to the first terminal, where the data of the plurality of scene image frames is used to run scene progress of the virtual scene from initial progress to target progress, and the target progress is scene progress at which the virtual scene is currently located.

In an aspect of this application, the server stores data of a plurality of virtual scenes, and based on a scene identifier of a virtual scene, obtains data of a plurality of scene image frames of the virtual scene. The plurality of scene image frames are all scene image frames in a running process of the virtual scene, the data of the scene image frames includes data used to perform operation logic and data used to perform rendering logic. In this process, the first terminal can render the plurality of scene image frames based on the data of the plurality of scene image frames. In other words, the first terminal can run the scene progress of the virtual scene from the initial progress to the target progress based on the data of the plurality of scene image frames, to implement fast frame chasing of the virtual scene. The initial progress is scene progress at which the virtual scene is first created, and may also be referred to as zero progress.

203: In response to the first terminal running the scene progress of the virtual scene to the target progress, the server transmits an object loading instruction carrying the object identifier to the first terminal and the at least one second terminal to enable the first terminal and the at least one second terminal to load the target virtual object in the virtual scene.

In an aspect of this application, in a case that the first terminal runs the scene progress of the virtual scene to the target progress, the server transmits the object loading instruction to the first terminal and the at least one second terminal. The object loading instruction transmitted by the server to the at least one second terminal carries the object identifier of the target virtual object. Then, in response to the object loading instruction, the first terminal and the at least one second terminal determine the target virtual object indicated by the object identifier, and load the target virtual object in the virtual scene.

An aspect of this application provides a virtual scene synchronization solution. When a target virtual object controlled by a first terminal requests to join a virtual scene, data of a scene image frame is returned to the first terminal in a process in which scene progress of the virtual scene is run from initial progress to target progress, so that the first terminal can perform fast frame chasing based on the obtained data. In this way, the first terminal can run the scene progress of the virtual scene from the initial progress to the target progress. When the virtual scene of the first terminal is run to the target progress, an object loading instruction carrying an object identifier is transmitted to the first terminal and at least one second terminal at which a virtual object in the virtual scene is located, so that each terminal can load the target virtual object in the virtual scene at the target progress. This realizes synchronous display of the virtual scene on each terminal, makes an occasion for the target virtual object to join the virtual scene unrestricted, ensures consistency of displaying the virtual scene on each terminal no matter when the virtual object requests to join the virtual scene, and improves flexibility of participating in the virtual scene.

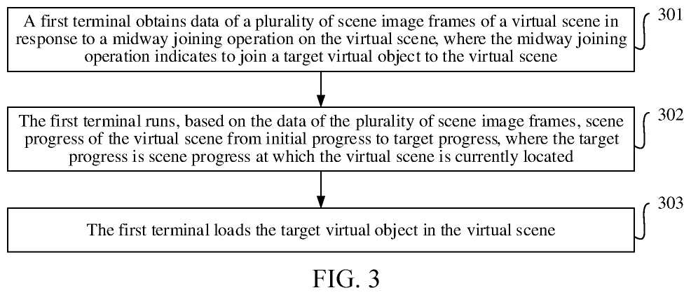

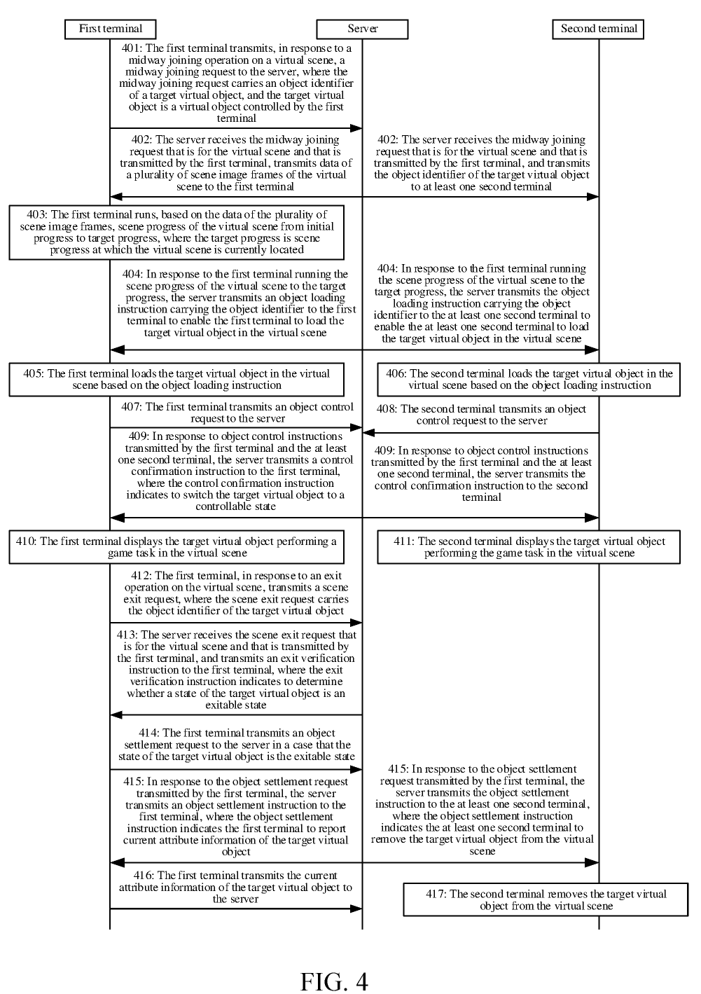

FIG. 3 is a flowchart of a virtual scene display method according to an aspect of this application. FIG. 3 is illustrated by taking execution by a first terminal as an example in an aspect of this application. The virtual scene display method includes the following operations.

301: A first terminal obtains data of a plurality of scene image frames of a virtual scene in response to a midway joining operation on the virtual scene, where the midway joining operation indicates to join a target virtual object to the virtual scene.

Data synchronization is performed on the virtual scene in a frame synchronization manner, and the plurality of scene image frames are all scene image frames in a running process of the virtual scene. In an aspect of this application, a user can trigger the midway joining operation on the virtual scene on the first terminal through a user account registered on the first terminal.

In some aspects, the terminal generates a midway joining request based on the midway joining operation, where the midway joining request carries an object identifier of the target virtual object and a scene identifier of the virtual scene; the terminal transmits the midway joining request to a server; the server receives the midway joining request and obtains the scene identifier in the midway joining request; and the server determines the virtual scene indicated by the scene identifier based on the scene identifier. The server then obtains the data of the plurality of scene image frames in the running process of the virtual scene, and then, returns the data to the first terminal.

302: The first terminal runs, based on the data of the plurality of scene image frames, scene progress of the virtual scene from initial progress to target progress, where the target progress is scene progress at which the virtual scene is currently located.

In an aspect of this application, there is a currently existing virtual object controlled by at least one second terminal in the virtual scene, and scene progress of the virtual scene displayed on the at least one second terminal is the target progress. The target virtual object manipulated by the first terminal is a midway joined virtual object. Therefore, to keep the first terminal and the at least one second terminal synchronized, the first terminal performs fast frame chasing on the virtual scene based on the data of the plurality of scene image frames, that is, quickly runs the scene progress of the virtual scene from the initial progress to the target progress.

303: The first terminal loads the target virtual object in the virtual scene.

In an aspect of this application, in a case that the scene progress of the virtual scene of the first terminal is the target progress, the first terminal loads the target virtual object in the virtual scene. When the first terminal loads the target virtual object, the at least one second terminal also loads the target virtual object in the virtual scene.

An aspect of this application provides a virtual scene display solution. When a target virtual object controlled by a first terminal requests to join a virtual scene, data of a scene image frame obtained in a process in which scene progress of the virtual scene is run from initial progress to target progress is obtained, so that the first terminal can perform fast frame chasing based on the obtained data, to run the scene progress of the virtual scene from the initial progress to the target progress, and then, to load the target virtual object in the virtual scene. In this way, the scene progress of the virtual scene displayed by the first terminal is synchronized with scene progress of the virtual scene displayed by another terminal. This makes an occasion for the target virtual object to join the virtual scene unrestricted, ensures consistency of displaying the virtual scene on each terminal no matter when the virtual object requests to join the virtual scene, and improves flexibility of participating in the virtual scene.

FIG. 4 is an interaction flowchart of a virtual scene synchronization method according to an aspect of this application. FIG. 4 is illustrated by taking an interaction between a terminal and a server as an example in an aspect of this application. The virtual scene synchronization method includes the following operations.

401: A first terminal transmits, in response to a midway joining operation on a virtual scene, a midway joining request to a server, where the midway joining request carries an object identifier of a target virtual object, and the target virtual object is a virtual object controlled by the first terminal.

Data synchronization is performed on the virtual scene in a frame synchronization manner. In an aspect of this application, the target virtual object may request to join the virtual scene midway from another virtual scene when the virtual scene is currently in operation, or may request to join the virtual scene midway without being in the virtual scene. Accordingly, that the target virtual object may request to join the target scene midway includes the following three cases.

In case 1, the virtual scene is one of a plurality of virtual scenes included in a virtual game. The plurality of virtual scenes are separately synchronized in a frame synchronization manner. During progress of the virtual game, the target virtual object is in another virtual scene in the virtual game than the virtual scene. In this case, the target virtual object can request to join the virtual scene midway from the another virtual scene. Accordingly, the first terminal displays a first virtual scene, where the target virtual object and a midway joining control are displayed in the first virtual scene. The first virtual scene is another virtual scene in which the target virtual object is currently located. Then, in a case that the midway joining control is triggered, it is determined that the target virtual object requests to join a second virtual scene, and the first terminal transmits the midway joining request to the server. The first virtual scene and the second virtual scene each are a virtual scene in the virtual game, and the first virtual scene and the second virtual scene are independent from each other and do not affect each other. According to the solution provided by the aspects of this application, when the target virtual object requests to join the second virtual scene from the first virtual scene in the virtual game, the midway joining request is transmitted to the server, so that the target virtual object can be joined midway from one virtual scene to another virtual scene in the virtual game.

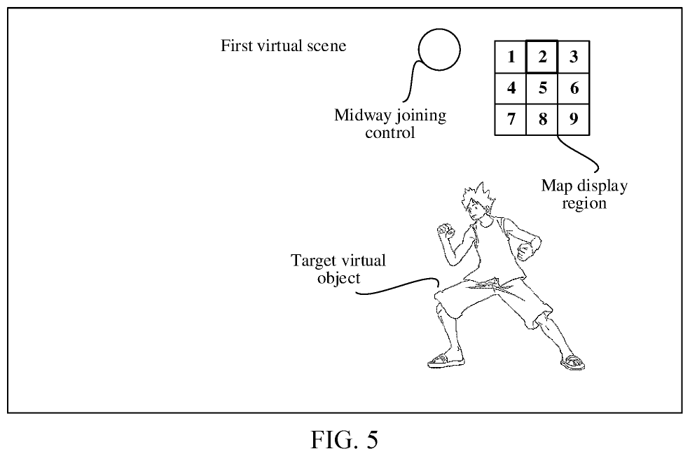

For example, FIG. 5 is a schematic diagram of the first virtual scene according to an aspect of this application. Refer to FIG. 5. A target virtual object, a midway joining control, a map display region, and the like are displayed in the first virtual scene. Nine virtual scenes of the virtual game are included in the map display region. A virtual scene numbered 2 is the first virtual scene in which the target virtual object is located. The target virtual object can perform, in the first virtual scene, a game task in the first virtual scene. A virtual scene numbered 5 is the second virtual scene. The second virtual scene may be determined by triggering numbers in the map display region. The midway joining control is triggered, so that the target virtual object can join the second virtual scene numbered 5 from the first virtual scene numbered 2.

In case 2, the virtual scene is one of a plurality of virtual scenes included in a virtual game. When the virtual game starts, the target virtual object does not participate in the virtual game, and is not in any virtual scene. Alternatively, when the virtual game starts, the target virtual object participates in the virtual game, but the target virtual object is in a waiting state, and is not in any virtual scene. At this time, the target virtual object requests to join the virtual scene in such a process that the first terminal displays an object selection interface in which a plurality of virtual objects are displayed. The first terminal displays a scene selection interface in response to a selection operation on the target virtual object, where a plurality of virtual scenes of the virtual game are displayed in the scene selection interface. The first terminal transmits the midway joining request to the server in response to a selection operation on a virtual scene. It is also possible not to select a virtual scene but to randomly add the target virtual object to any one of the plurality of virtual scenes.

In case 3, this virtual scene is the only virtual scene of the virtual game. When the virtual game starts, the target virtual object does not participate in the virtual game, and does not join the virtual scene. Alternatively, when the virtual game starts, the target virtual object participates in the virtual game, but the target virtual object is in a waiting state, and does not join the virtual scene. The target virtual object requests to join the virtual scene in such a process that the first terminal displays an object selection interface in which a plurality of virtual objects are displayed. The first terminal transmits the midway joining request to the server in response to a selection operation on the target virtual object. The midway joining request carries the object identifier of the target virtual object.

In the above case 2 and case 3, when the target virtual object is not in the virtual scene and requests to join the virtual scene, the midway joining request is transmitted to the server, so that in a case that the target virtual object is not in the virtual scene, the target virtual object can join a virtual scene of the virtual game midway. This makes an occasion to join the virtual game unrestricted, allows the virtual object to freely join the virtual scene, and improves flexibility of participating in the virtual game.

In some aspects, the target virtual object may actively request to join the virtual scene or may request to join the virtual scene in a case that an invitation to any virtual object in the virtual scene is received. A joining manner in which the target virtual object joins the virtual scene midway includes the following three manners.

In joining manner 1, the target virtual object actively requests to join the virtual scene by selecting the virtual scene in the map display region. In this case, the first terminal displays the first virtual scene, where the map display region is displayed in the first virtual scene, and the map display region includes scene identifiers of the plurality of virtual scenes. In response to a trigger operation on a scene identifier of any virtual scene, the first terminal transmits the midway joining request to the server to enable the target virtual object to join the virtual scene from the first virtual scene.

In joining manner 2, the target virtual object actively requests to join a virtual scene by entering a virtual channel of the virtual scene. There is a virtual channel connection between the plurality of virtual scenes of the virtual game, and in response to the target virtual object joining the virtual channel of the virtual scene, the first terminal transmits the midway joining request to the server, to enable the target virtual object to join the virtual scene through the virtual channel from the first virtual scene.

In joining manner 3, the target virtual object is invited to join the virtual scene. In a case that any virtual object in the virtual scene transmits an invitation to the target virtual object, the first terminal displays invitation prompt information and a midway joining control, and in response to a trigger operation on the midway joining control, the first terminal transmits the midway joining request to the server, to enable the target virtual object to join the virtual scene from the first virtual scene and support another virtual object in the virtual scene.

402: The server receives the midway joining request that is for the virtual scene and that is transmitted by the first terminal, transmits data of a plurality of scene image frames of the virtual scene to the first terminal, and transmits the object identifier of the target virtual object to at least one second terminal.

In an aspect of this application, the virtual scene includes a virtual object controlled by the at least one second terminal. The plurality of scene image frames are all scene image frames in a running process of the virtual scene, and the data of the plurality of scene image frames includes a sequence of operation instructions between a server and a terminal associated with the virtual scene, data used to render the virtual scene, and data used to render the virtual object. The terminal associated with the virtual scene indicates a terminal corresponding to a virtual object appearing in the virtual scene. The operation instruction sequence includes a plurality of object control instructions. The object control instructions are used for controlling the virtual object, and include an attack instruction, an escape instruction, a posture adjustment instruction, or the like. This is not limited in aspects of this application. The data of the plurality of scene image frames further includes an object creation instruction and an object removal instruction between the server and the terminal associated with the virtual scene.

The target virtual object may join or exit the virtual scene midway several times, and during each time the target virtual object joins the virtual scene midway, the first terminal may run, based on the data of the plurality of scene image frames, scene progress of the virtual scene from initial progress to currently located scene progress; or may save the virtual scene at exit progress when the target virtual object exits the virtual scene, so as to start running from the exit progress to the scene progress at which the virtual scene is currently located when the target virtual object joins the virtual scene midway. This improves synchronization progress. The above-described process of running the scene progress of the virtual scene from certain progress to currently located scene progress may be referred to as fast frame chasing.

In some aspects, the server may divide the data in the scene image frame into first type of data and second type of data. The first type of data is used to perform operation logic, and the second type of data is used to perform rendering logic. The first terminal performs a large amount of operation logic and rendering logic in a short time, the first terminal loads the virtual scene and the virtual object at a slower speed, resulting in longer time-consuming synchronization of the first terminal and another terminal. This degrades user experience. Therefore, the server can select partial data from the data of the plurality of scene image frames to transmit the partial data to the first terminal, so that the first terminal runs the scene progress of the virtual scene from the initial progress to the currently located scene progress based on the received partial data, to reduce synchronization time consumption and improve synchronization efficiency. A manner in which the server transmits data to the first terminal includes the following four types.

In transmitting manner 1, if the first terminal does not display each scene image frame during fast frame chasing, rendering of the scene image frame is unnecessary, and the server may not transmit the second type of data used to perform the rendering logic to the first terminal, but only transmit the first type of data used to perform the operation logic to the first terminal. Correspondingly, the server obtains data used to load the plurality of scene image frames of the virtual scene. Then, the server obtains a first type of data of the plurality of scene image frames from the data of the plurality of scene image frames based on attribute information of the data. The server transmits the first type of data of the plurality of scene image frames to the first terminal. The attribute information of the data indicates use of the data, that is, indicates that the data is used to perform the rendering logic or the operation logic. According to the solutions provided by aspects of this application, only the first type of data used to perform the operation logic is transmitted to the first terminal, so that the first terminal can run the scene progress of the virtual scene from the initial progress to the currently located scene progress only by processing the first type of data of the plurality of scene image frames. In this way, less data is processed, so that efficiency of running the virtual scene to the currently located scene progress can be improved.

In transmitting manner 2, if the first terminal does not perform the rendering logic, a special effect of a skill released by the virtual object in the virtual scene at the end of fast frame chasing cannot be presented, so that a user may perform a misoperation because the user cannot see the special effect of the skill, for example, manipulating the target virtual object into a range of the special effect of the skill. Thus, based on the fact that the first type of data of the plurality of scene image frames is transmitted to the first terminal, the server may further transmit a second type data of some scene image frames to the first terminal. Accordingly, the server obtains a plurality of target scene image frames in a target frame quantity range from the plurality of scene image frames. Then, the server transmits a second type of data of the plurality of target scene image frames to the first terminal. The target frame quantity range is 60 frames, 90 frames, or 120 frames in the last order of the plurality of scene image frames. This is not limited in aspects of this application. During fast frame chasing by the first terminal, the virtual scene may generate new scene image frame data, and the server transmits the newly generated scene image frame data to the first terminal. The first terminal selects, from back to front in a chronological order, a plurality of scene image frames in the target frame quantity range for rendering. According to the solutions provided by aspects of this application, based on the fact that the first type of data of the plurality of scene image frames is transmitted to the first terminal, the second type of data of the plurality of target scene image frames in the last order is also transmitted to the first terminal, so that the first terminal can perform rendering based on the second type of data of the plurality of target scene image frames. In this way, when the virtual scene is run to the currently located scene progress, the first terminal can present a situation in the virtual scene, and the user is avoided to perform a misoperation caused by the fact that the first terminal does not present a skill special effect of a skill released by another virtual object.

In transmitting manner 3, there may be a longer lasting skill specific effect in the virtual scene. The skill specific effect may remain after the target virtual object is loaded. These skill specific effects, if not rendered, may result in a failure to present the skill specific effect after fast frame chasing ends. Thus, the server may set priorities for different rendering content, where relatively important rendering content may set with a higher priority, and relatively unimportant rendering content may set with a lower priority. For example, a priority of rendering content of the longer lasting skill specific effect may be higher if the rendering content of the longer lasting skill specific effect is more important. Based on the fact that the first type of data of the plurality of scene image frames is transmitted to the first terminal, the server may further transmit data of rendering content with a higher priority to the first terminal. Accordingly, the server determines a plurality of pieces of rendering content based on the data of the plurality of scene image frames. Then, the server obtains, from the data of the plurality of scene image frames, data of target rendering content, where a rendering priority of the target rendering content is higher than a target priority, and the target priority may be flexibly set by the server. Then, the server transmits the data of the target rendering content to the first terminal. The data of the target rendering content is partial data of a second type of data of a scene image frame in which the target rendering content is located. According to the solutions provided by aspects of this application, based on the fact that the first type of data of the plurality of scene image frames is transmitted to the first terminal, the data of the target rendering content with the higher rending priority is further transmitted to the first terminal, so that the first terminal can present the target rendering content all the time. This avoids that the first terminal does not present the target rendering content, causing the user to perform a misoperation.

For example, the target rendering content is a flame trap released by a non-player character (NPC) of the virtual scene obtained when the scene progress of the virtual scene is the initial progress, where the flame trap lasts throughout the virtual game. In a process of running the scene progress of the virtual scene from the initial progress to the target progress, if the flame trap is not rendered by the first terminal, it may occur that the target virtual object is mistakenly manipulated into a range of the flame trap because the user does not see the flame trap, resulting in harm to the target virtual object, giving the user an illusion of bug, and resulting in poor user experience.

In transmitting manner 4, the server can alternatively simultaneously transmit the first type of data of the plurality of scene image frames, the second type of data of the plurality of target scene image frames in the last order, and the data of the target rendering content with the higher rendering priority to the first terminal. Details are not described herein again. According to the solutions provided by aspects of this application, the data is transmitted to the first terminal, so that the first terminal can run the scene progress of the virtual scene from the initial progress to the currently located scene progress without processing entire data of the plurality of scene image frames. In this way, less data is processed, so that efficiency of running the virtual scene to the currently located scene progress can be improved. Moreover, when the virtual scene is run to the currently located scene progress, the first terminal can present a situation in the virtual scene, and the target rendering content is displayed in the virtual scene, so as to prevent the user from performing a misoperation caused by the fact that the user does not see a skill special effect existing in the virtual scene.

The first terminal performs fast frame chasing every time the target virtual object joins the virtual scene midway. Therefore, the data of the plurality of scene image frames may include an initial setting of the virtual scene, namely, data of the virtual scene obtained when the scene progress is the initial progress. In addition to loading the target virtual object, the first terminal loads at least one first virtual object in the virtual scene, where the first virtual object is a virtual object present when the scene progress of the virtual scene is the initial progress. In order for the first terminal to be able to identify a to-be-loaded virtual object and to load the virtual object at a correct occasion, the server can mark the target virtual object and the at least one first virtual object. Occasions at which different virtual objects join the virtual scene may be different, and the server marks the virtual objects based on the occasions at which the virtual objects join the virtual scene, which may be divided into the following five cases.

In a first case, a virtual object has been present in the virtual scene from a moment when the scene progress of the virtual scene is the initial progress, namely, the start of creation of the virtual scene, to a current moment. Accordingly, the server marks, with a first marker, any first virtual object existing when the scene progress of the virtual scene is the initial progress. The first marker indicates that the first virtual object is always present in the virtual scene and has not exited. Then, the first terminal needs to load the first virtual object when the scene progress of the virtual scene is the initial progress.

In a second case, a virtual object was present at the time of creation of the virtual scene, but exited the virtual scene, and requests to join the virtual scene at the current moment. Since the virtual object was present at the time of creation of the virtual scene, the server marks the virtual object with a first marker. The server modifies the first marker when the virtual object requests to join the virtual scene after exiting the virtual scene. The target virtual object is used as an example. Accordingly, in response to the midway joining request of the target virtual object, it is determined whether the target virtual object exists in the virtual scene when the scene progress is the initial progress, that is, whether the target virtual object is the above-described first virtual object. In a case that the target virtual object exists in the virtual scene when the scene progress is the initial progress, that is, the target virtual object is the first virtual object, the server modifies the first marker of the target virtual object to a second marker. The second marker indicates that the target virtual object exited the virtual scene, and joins the virtual scene this time. Joining the virtual scene this time means joining when the virtual scene is in the target progress. Then, the first terminal needs to load the target virtual object when the scene progress of the virtual scene is the initial progress, remove the target virtual object when the target virtual object exits the virtual scene, and load the target virtual object again when the scene progress of the virtual scene is the target progress. The target virtual object may join and exit the virtual scene a plurality of times. This is described when a marker of the target virtual object is the first marker in this application. In some aspects, the marker of the target virtual object may alternatively be another marker. Details are given below.

In a third case, a virtual object was not present at the time of creation of the virtual scene, and requests to join the virtual scene at the current moment. Since the virtual object was not present when the virtual scene was created, the server can mark the virtual object when the virtual object first requests to join the virtual scene. That the virtual object is the target virtual object is used as an example. Accordingly, in response to the midway joining request of the target virtual object, the server determines whether the target virtual object exists in the virtual scene when the scene progress is the initial progress, that is, determines whether the target virtual object is the above-described first virtual object. If the target virtual object is present in the virtual scene when the scene progress is the initial progress, that is, the target virtual object is not the first virtual object, the server marks the target virtual object with a third marker. The third marker indicates that the target virtual object joins the virtual scene this time, and joins the virtual scene for the first time. Then, the first terminal needs to load the target virtual object when the scene progress of the virtual scene is the target progress.

In a fourth case, a virtual object was present at the time of creation of the virtual scene, but exited the virtual scene, and requested to join the virtual scene before the current moment. Since the virtual object was present at the time of creation of the virtual scene, and an initial marker is the first marker, then when the virtual object exited the virtual scene and joined the virtual scene again, the marker was modified to a second marker. When the target virtual object requests to join the virtual scene, the server can again modify the second marker of the virtual object. Accordingly, in response to the midway joining request for the target virtual object, the server obtains a marker of at least one second virtual object that was present in the virtual scene, where the marker of the second virtual object is the first marker, the second marker, or a third marker. The second virtual object is any virtual object that was present in the virtual scene. Then, in a case that a marker of any second virtual object is the second marker, the server modifies the second marker of the second virtual object to a fourth marker. The fourth marker indicates that the second virtual object does not join the virtual scene this time. Then, the first terminal needs to load the target virtual object when the scene progress of the virtual scene is the initial progress, and then remove and reload the target virtual object in the fast frame chasing process.

In a fifth case, a virtual object was not present at the time of creation of the virtual scene, and requested to join the virtual scene before the current moment. Since the virtual object was not present at the time of creation of the virtual scene, the server marks the virtual object with a third marker when the second virtual object requests to join the virtual scene for the first time. When the target virtual object requests to join the virtual scene, the server can modify the third marker of the virtual object. Accordingly, in response to the midway joining request for the target virtual object, the server obtains a marker of at least one second virtual object that was present in the virtual scene, where the marker of the second virtual object is a first marker, a second marker, or the third marker. In a case that the marker of the second virtual object is the third marker, the server modifies the third marker of the second virtual object to a fifth marker. The fifth marker indicates that the second virtual object does not join the virtual scene this time. Then, the first terminal needs to load the second virtual object when the second virtual object requests to join the virtual scene for the first time. There is a difference between the fourth marker and the fifth marker. The fourth marker indicates that the virtual object does not join the virtual scene this time, and that the virtual object was present at the time of creation of the virtual scene, but exited the virtual scene, and requested to join the virtual scene before the current moment. The fifth marker indicates that the virtual object does not join the virtual scene this time, and that the virtual object was not present at the time of creation of the virtual scene, and requested to join the virtual scene before the current moment.

According to the solutions provided by aspects of this application, a virtual object associated with the virtual scene is marked, so that the first terminal can load the virtual object at a corresponding occasion based on a marker carried by the virtual object in the process of fast frame chasing based on the data of plurality of scene image frames. This ensures that the first terminal can accurately restore the running process of the virtual scene, and this can further improve accuracy of loading the virtual scene and the virtual object in the virtual scene.

The server can further store object information of the virtual object associated with the virtual scene. The object information includes an object identifier, a marker carried by the virtual object, attribute information of the virtual object, and the like. The information pertains to the data of the plurality of scene image frames of the virtual scene. The marker carried by the virtual object indicates an occasion at which the first terminal loads the virtual object. In aspects of the present application, there is no restriction on a quantity of times the virtual object joins the virtual scene and a quantity of times the virtual object exits the virtual scene in the running process of the virtual scene.

403: The first terminal runs, based on the data of the plurality of scene image frames, the scene progress of the virtual scene from the initial progress to the target progress, where the target progress is scene progress at which the virtual scene is currently located.

In aspects of this application, the first terminal obtains the data of the plurality of scene image frames of the virtual scene from the server, where the data of the plurality of scene image frames may be entire data of the plurality of scene image frames or partial data processed by the server. This is not limited in aspects of this application. The first terminal may quickly display the plurality of scene image frames arranged in time sequence, or the first terminal may alternatively display only a loading interface without displaying the plurality of scene image frames. At least one loading progress bar is displayed on the loading interface. Through the at least one loading progress bar, progress of the first terminal loading the virtual scene and progress of the at least one second terminal loading the target virtual object can be visually displayed.

In some aspects, the data of the plurality of scene image frames obtained by the first terminal is the entire data of the plurality of scene image frames. Data of any scene image frame includes a first type of data and a second type of data. The first type of data is used to perform operation logic, and the second type of data is used to perform rendering logic. The first terminal performs a large amount of operation logic and rendering logic in a short time, the first terminal loads the virtual scene and the virtual object at a slower speed, resulting in longer time-consuming synchronization of the first terminal and another terminal. This degrades user experience. Therefore, the first terminal can select partial data from the entire data of the plurality of scene image frames to load the virtual scene. A manner in which the first terminal loads the virtual scene includes the following four manners.

In loading manner 1, if each scene image frame is not displayed during fast frame chasing, rendering of the scene image frame is unnecessary, and the first terminal can obtain the first type of data used to perform the operation logic to load the virtual scene, such that the scene progress of the virtual scene is run from the initial progress to the target progress. Accordingly, the first terminal loads the virtual scene obtained when the scene progress is the initial progress. Then, the first terminal obtains the first type of data of the plurality of scene image frames from the data of the plurality of scene image frames based on the attribute information of the data. Then, the first terminal runs, based on the first type of data of the plurality of scene image frames, the scene progress of the virtual scene from the initial progress to the target progress. The attribute information of the data indicates use of the data, that is, indicates that the data is used to perform the rendering logic or the operation logic. According to the solutions provided by aspects of this application, only the first type of data of the plurality of scene image frames needs to be processed, so that the scene progress of the virtual scene can be run from the initial progress to the currently located scene progress. Because less data is processed, efficiency of running the virtual scene to the currently located scene progress can be improved.

In loading manner 2, if the first terminal entirely does not perform the rendering logic, a special effect of a skill released by the virtual object in the virtual scene at the end of fast frame chasing cannot be presented, so that the user may perform a misoperation because the user cannot see the special effect of the skill, for example, manipulating the target virtual object into a range of the special effect of the skill, resulting in harm to the target virtual object. Therefore, the first terminal can further obtain a second type of data of some scene image frames from the data of the plurality of scene image frames based on the fact that the first type of data of the plurality of scene image frames is obtained. Accordingly, the first terminal obtains a plurality of target scene image frames in a target frame quantity range from the plurality of scene image frames. Then, the first terminal obtains a second type of data of the plurality of target scene image frames. Then, the first terminal runs, based on the second type of data of the plurality of target scene image frames and the first type of data of the plurality of scene image frames, the scene progress of the virtual scene from the initial progress to the target progress. The target frame quantity range is 60 frames, 90 frames, or 120 frames in the last order of the plurality of scene image frames. This is not limited in aspects of this application. According to the solutions provided by aspects of this application, the first type of data of the plurality of scene image frames and the second type of data of the plurality of target scene image frames in the last order are obtained, so that the first terminal can perform rendering based on the second type of data of the plurality of target scene image frames. In this way, when the virtual scene is run to the currently located scene progress, the first terminal can present a situation in the virtual scene, and the user is avoided to perform a misoperation caused by the fact that the first terminal does not present a skill special effect of a skill released by another virtual object.

In loading manner 3, there may be a longer lasting skill specific effect in the virtual scene. The skill specific effect may remain after the target virtual object is loaded. These skill specific effects, if not rendered, may result in a failure to present the skill specific effect after fast frame chasing ends. Therefore, based on the fact that the first type of data of the plurality of scene image frames is obtained, the first terminal can further obtain data of rendering content with a higher priority. The rendering content with the higher priority is content that needs to be rendered. Accordingly, the first terminal determines a plurality of pieces of rendering content based on the data of the plurality of scene image frames. Then, the first terminal obtains, from the data of the plurality of scene image frames, data of target rendering content, where a rendering priority of the target rendering content is higher than a target priority. Then, the first terminal runs, based on the data of the target rendering content and the first type of data of the plurality of scene image frames, the scene progress of the virtual scene from the initial progress to the target progress. The data of the target rendering content is partial data of a second type of data of a scene image frame in which the target rendering content is located. According to the solutions provided by aspects of this application, the first type of data of the plurality of scene image frames and the data of the target rendering content with the higher rending priority are obtained, so that the first terminal can present the target rendering content all the time. This avoids that the first terminal does not present the target rendering content, causing the user to perform a misoperation.

In loading manner 4, the first terminal can alternatively simultaneously obtain, from the data of the plurality of scene image frames, the first type of data of the plurality of scene image frames, the second type of data of the plurality of target scene image frames in the last order, and the data of the target rendering content with the higher rendering priority, so as to run the scene progress of the virtual scene from the initial progress to the target progress based on the data. Details are not described in detail herein again. According to the solutions provided by aspects of this application, the above data is obtained from the entire data of the plurality of scene image frames, so that the first terminal can run the scene progress of the virtual scene from the initial progress to the currently located scene progress without processing entire data of the plurality of scene image frames. In this way, less data is processed, so that efficiency of running the virtual scene to the currently located scene progress can be improved. Moreover, when the virtual scene is run to the currently located scene progress, the first terminal can present a situation in the virtual scene, and the target rendering content is displayed in the virtual scene, so as to prevent the user from performing a misoperation caused by the fact that the user does not see a skill special effect existing in the virtual scene.

In some aspects, the first terminal can render the virtual scene in both a partially rendering manner and a fully rendering manner. Accordingly, the first terminal displays the virtual scene obtained when the scene progress is the initial progress. Then, the first terminal divides the data of the plurality of scene image frames in time sequence into a first frame data group and a second frame data group. Then, the first terminal renders the virtual scene in the partially rendering manner based on the first frame data group. Then, the first terminal renders the virtual scene in the fully rendering manner based on the second frame data group, such that the virtual scene is loaded to the target progress. The first frame data group is earlier in time sequence than the second frame data group. More detail can be rendered in the fully rendering manner than in the partially rendering manner. The partially rendering manner may only be used to render, in the virtual scene, a skill specific effect with a higher rendering priority, or may only be used to render outlines of the virtual object, a scene element in the virtual scene. This is not limited in aspects of this application. According to the solutions provided by aspects of this application, the virtual scene is rendered in both the partially rendering manner and the fully rendering manner, so that the scene progress of the virtual scene can be run from the initial progress to the currently located scene progress. Because less data is processed, efficiency of running the virtual scene to the currently located scene progress can be improved.

In some aspects, the virtual object associated with the virtual scene carries a marker, and the first terminal can load the virtual object based on the marker. Accordingly, the first terminal determines, based on the data of the plurality of scene image frames, a marker of at least one virtual object associated with the virtual scene. Then, in the virtual scene of which the scene progress is the initial progress in a case that a target marker exists, a virtual object having the target marker is loaded. The target marker indicates that the virtual object is present at the virtual scene when the scene progress is the initial progress. The target marker may be the first marker, the second marker, or the fourth marker. This is not limited in aspects of this application. According to the solutions provided by aspects of this application, the virtual object is loaded at a corresponding occasion based on the marker carried by the virtual object. This ensures that the first terminal can accurately restore the running process of the virtual scene, and this can further improve accuracy of the virtual scene and the virtual object in the virtual scene.

When the first terminal runs the virtual scene to the target progress, the first terminal can transmit an object loading request to the server, where the object loading request carries the object identifier of the target virtual object. The first terminal requests the server to allow loading the target virtual object.

In a process in which the first terminal runs the scene progress of the virtual scene from the initial progress to the target progress, data of new scene image frame is further generated in the virtual scene. The first terminal can receive the data of the new scene image frame transmitted by the server. After the first terminal runs the virtual scene to the target progress, the first terminal continues to load the virtual scene based on the data of the new scene image frame.

404: In response to the first terminal running the scene progress of the virtual scene to the target progress, the server transmits an object loading instruction carrying the object identifier to the first terminal and the at least one second terminal to enable the first terminal and the at least one second terminal to load the target virtual object in the virtual scene.

In aspects of this application, the server receives the object loading request transmitted by the first terminal. The server determines that the first terminal runs the scene progress of the virtual scene to the target progress based on the object loading request. Then, the server transmits the object loading instruction to the first terminal and the at least one second terminal. The object loading instruction carries the object identifier of the target virtual object, so that the first terminal and the at least one second terminal separately create the target virtual object based on the object identifier. The server may simultaneously transmit the object loading instruction to the first terminal and the at least one second terminal, at which time the object loading instruction indicates terminals to create the target virtual object upon receiving the object loading instruction; or may separately transmit the object loading instruction to the first terminal and the at least one second terminal at different time, at which time the object loading instruction indicates terminals to create the target virtual object in the scene image frame indicated by the object loading instruction. This is not limited in aspects of this application.

Then, the server receives the midway joining request transmitted by the first terminal, the server can forward the object identifier of the target virtual object carried in the midway joining request to the at least one second terminal, to inform the at least one second terminal that the target virtual object requests to join the virtual scene. The at least one second terminal can preload the target virtual object based on the object identifier. Then, the object loading instruction may not carry the object identifier of the target virtual object.

405: The first terminal loads the target virtual object in the virtual scene based on the object loading instruction.

In aspects of this application, loading the target virtual object includes two operations: creating the target virtual object and displaying the target virtual object. After the creation of the target virtual object is completed, the first terminal may locally obtain a special effect resource of the target virtual object based on the object identifier of the target virtual object, where the special effect resource is used to present the target virtual object joining the virtual scene. Then, the first terminal displays the special effect resource and the target virtual object in the virtual scene.

In some aspects, the first terminal can further preload the target virtual object in the virtual scene before the scene progress of the virtual scene is loaded to the target progress. When the scene progress of the virtual scene is loaded to the target progress, the preloaded target virtual object is displayed. The preloaded content may be a three-dimensional model of the target virtual object. This is not limited in aspects of this application. According to solutions provided by aspects of this application, a speed of loading the target virtual object can be increased by preloading the target virtual object in a process in which the scene progress of the virtual scene is loaded from the initial progress to the target progress. In this way, efficiency of joining the target virtual object midway to the virtual scene is increased.

406: The second terminal loads the target virtual object in the virtual scene based on the object loading instruction.

In aspects of this application, any second terminal is used as an example. After receiving the object loading instruction, the second terminal creates the target virtual object. After the creation of the target virtual object is completed, the second terminal locally obtains a special effect resource of the target virtual object based on the object identifier of the target virtual object. Then, the special effect resource and the target virtual object are displayed in the virtual scene.

The numbering of the operations in aspects of this application is for convenience of description, and does not limit an execution order of the operations. For example, operation 405 may be performed before operation 406, may be performed after operation 406, or may be performed in synchronization with operation 406. This is not limited in aspects of this application.

407: The first terminal transmits an object control request to the server.

In aspects of this application, the object control request carries the object identifier of the target virtual object, and is used to request the target virtual object to switch to a controllable state.

408: The second terminal transmits an object control request to the server.

In aspects of this application, the object control request carries the object identifier of the target virtual object, and is used to request the target virtual object to switch to a controllable state.

The numbering of the operations in aspects of this application is for convenience of description, and does not limit an execution order of the operations. For example, operation 407 may be performed before operation 408, may be performed after operation 408, or may be performed in synchronization with operation 408. This is not limited in aspects of this application.

409: In response to object control instructions transmitted by the first terminal and the at least one second terminal, the server transmits a control confirmation instruction to the first terminal and the at least one second terminal, where the control confirmation instruction indicates to switch the target virtual object to the controllable state.

In aspects of this application, the server transmits the control confirmation instruction to the first terminal and the at least one second terminal only in a case that the object control instruction transmitted by the first terminal and the object control instruction transmitted by the at least one second terminal are received, where the object control instruction indicates the first terminal and the at least one second terminal to switch the target virtual object from an uncontrollable state to the controllable state at the same moment to ensure synchronization. The server may simultaneously transmit the object control instruction to the first terminal and the at least one second terminal, where the object control instruction indicates the terminals to switch the target virtual object from the uncontrollable state to the controllable state when the terminals receive the object control instruction; or may transmit the object control instruction to the first terminal and the at least one second terminal at different time, at which time the object control instruction indicates the terminals to switch the target virtual object from the uncontrollable state to the controllable state when the terminals display the scene image frame indicated by the object control instruction. This is not limited in aspects of this application.

410: The first terminal displays the target virtual object performing a game task in the virtual scene.

In aspects of this application, the first terminal switches the target virtual object to the controllable state in response to the control confirmation instruction transmitted by the server. Then, the first terminal manipulates the target virtual object into performing the game task in the virtual scene. Since a plurality of virtual scenes of the virtual game are mutually independent, a plurality of game tasks corresponding to the plurality of virtual scenes are also mutually independent. When the target virtual object is in the controllable state, the target virtual object may attack another virtual object and may be attacked by another virtual object as well.

411: The second terminal displays the target virtual object performing a game task in the virtual scene.

In aspects of this application, the second terminal switches the target virtual object to the controllable state in response to the control confirmation instruction transmitted by the server. Then, the second terminal separately displays various activities performed by the target virtual object in the virtual scene. When the target virtual object is in the controllable state, the target virtual object may interact with another virtual object under the control of the user account.

For example, operation 410 may be performed before operation 411, may be performed after operation 411, or may be performed in synchronization with operation 411. This is not limited in aspects of this application.

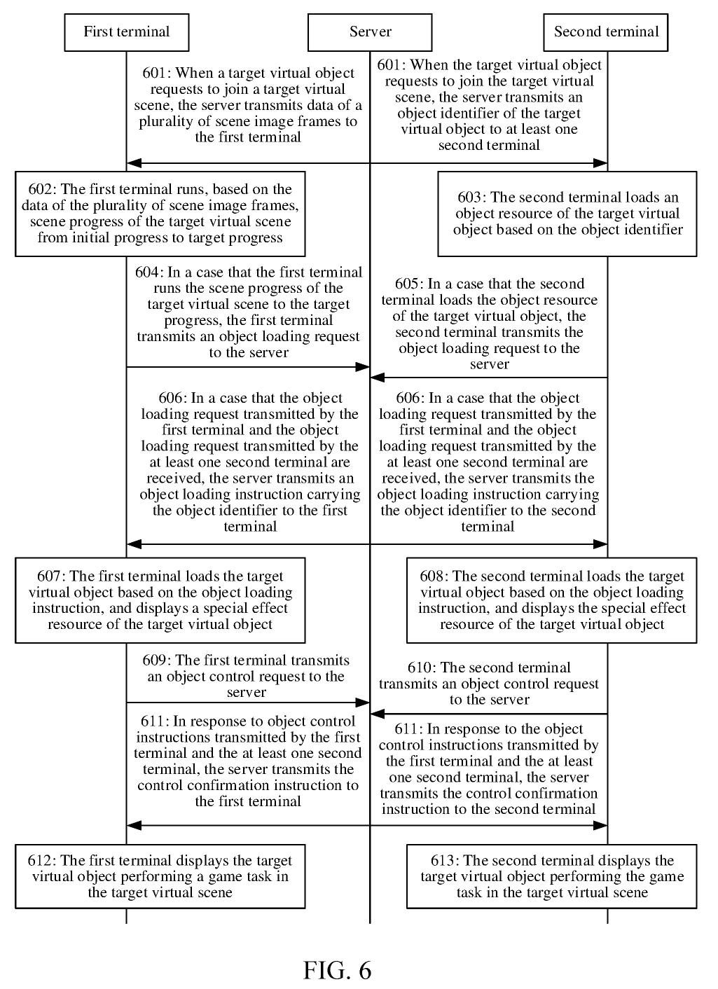

To more clearly describe a process in which the target virtual object requests to join the virtual scene, the process is further described below with reference to the accompanying drawings. FIG. 6 is a flowchart of an interaction of a target virtual object joining a virtual scene according to an aspect of this application. Refer to FIG. 6. The process in which the target virtual object requests to join the virtual scene may be implemented by the following operation 601 to operation 613. 601: When the target virtual object requests to join the virtual scene, the server transmits the data of the plurality of scene image frames to the first terminal and transmits the object identifier of the target virtual object to the at least one second terminal. 602: The first terminal runs, based on the data of the plurality of scene image frames, the scene progress of the virtual scene from the initial progress to the target progress. 603: The at least one second terminal loads an object resource of the target virtual object based on the object identifier. 604: In a case that the first terminal runs the scene progress of the virtual scene to the target progress, the first terminal transmits the object loading request to the server. 605: In a case that any second terminal loads the object resource of the target virtual object, the second terminal transmits the object loading request to the server, where the object loading request carries the object identifier of the target virtual object. 606: In a case that the object loading request transmitted by the first terminal and the object loading request transmitted by the at least one second terminal are received, the server transmits the object loading instruction carrying the object identifier to the first terminal and the at least one second terminal. 607: The first terminal loads the target virtual object based on the object loading instruction, and displays the special effect resource of the target virtual object. 608: The second terminal loads the target virtual object based on the object loading instruction, and displays the special effect resource of the target virtual object. 609: The first terminal transmits the object control request to the server. 610: The second terminal transmits the object control request to the server. 611: In response to object control instructions transmitted by the first terminal and the at least one second terminal, the server transmits the control confirmation instruction to the first terminal and the at least one second terminal. 612: The first terminal displays the target virtual object performing the game task in the virtual scene. 613: The second terminal displays the target virtual object performing the game task in the virtual scene.

412: The first terminal, in response to an exit operation on the virtual scene, transmits a scene exit request, where the scene exit request carries the object identifier of the target virtual object.

In aspects of this application, the exit operation is triggered, so that the target virtual object can request to exit the virtual scene. The first terminal transmits the scene exit request to the server in response to the exit operation. Since the object identifier of the target virtual object is carried in the scene exit request, the server can determine a virtual object to exit the virtual scene.

413: The server receives the scene exit request that is for the virtual scene and that is transmitted by the first terminal, and transmits an exit verification instruction to the first terminal, where the exit verification instruction indicates to determine whether a state of the target virtual object is an exitable state.

In aspects of this application, in a case that the scene exit request that is for the virtual scene and that is transmitted by the first terminal is received, the server transmits the exit verification instruction to the first terminal. The exit verification instruction carries the object identifier of the target virtual object. The exit verification instruction indicates the first terminal to perform verification when a scene image frame indicated by the exit verification instruction is displayed. This is not limited in aspects of this application. The first terminal verifies the target virtual object based on the object identifier. A non-exitable state is a state of being attacked, a state of joining the virtual scene, a state of releasing a skill, or the like. This is not limited in aspects of this application.

Since the virtual scene of the first terminal and the virtual scene of the at least one second terminal are synchronized, the server may not need to transmit the exit verification instruction to the at least one second terminal, and only transmit the exit verification instruction to the first terminal, to allow the target virtual object to exit the virtual scene in a case that the first terminal determines that the target virtual object is in the exitable state. Further, after the target virtual object exits the virtual scene, the server synchronizes this event to the at least one second terminal.

In some aspects, the server separately transmits the exit verification instruction to the first terminal and the at least one terminal second in a case that the scene exit request transmitted by the first terminal is received. The server may simultaneously transmit the exit verification instruction to the first terminal and the at least one second terminal; or may transmit the exit verification instruction to the first terminal and the at least one second terminal at different time, where the exit verification instruction indicates the terminals to perform verification when the scene image frame indicated by the exit verification instruction is displayed. This is not limited in aspects of this application. The first terminal and the at least one second terminal verify the target virtual object based on the object identifier. The virtual object controlled by the second terminal is any virtual object in the virtual scene other than the target virtual object.

414: The first terminal transmits an object settlement request to the server in a case that the state of the target virtual object is the exitable state.

In aspects of this application, the first terminal determines the state of the target virtual object. Then, the first terminal transmits the object settlement request to the server in a case that the state of the target virtual object is the exitable state. The object settlement request is used to request the server to indicate the first terminal to settle attribute information of the target virtual object at the current moment.

415: In response to the object settlement request transmitted by the first terminal, the server transmits an object settlement instruction to the first terminal and the at least one second terminal, where the object settlement instruction indicates the first terminal to report current attribute information of the target virtual object, and indicates the at least one second terminal to remove the target virtual object from the virtual scene.

In aspects of this application, the server may simultaneously transmit the object settlement instruction to the first terminal and the at least one second terminal, at which time the object settlement instruction indicates the terminals to report the current attribute information of the target virtual object upon receiving the object settlement instruction; or may transmit the object settlement instruction to the first terminal and the at least one second terminal at different time, at which time the object settlement instruction indicates the terminals to report the current attribute information of the target virtual object when displaying a scene image frame indicated by the object settlement instruction. This is not limited in aspects of this application. The attribute information of the target virtual object includes information such as a virtual life value, an attack force, and a defense force of the target virtual object. When the first terminal receives the object settlement instruction, the first terminal can settle the attribute information of the target virtual object. At this time, the attribute information of the target virtual object does not change any more. The first terminal performs settlement based on attribute information of the target virtual object when the target virtual object joins the virtual scene and a part of the attribute information consumed in the virtual scene. When the at least one second terminal receives the object settlement instruction, the at least one second terminal removes the target virtual object from the virtual scene, that is, does not display the target virtual object any more

416: The first terminal transmits the current attribute information of the target virtual object to the server.

In aspects of this application, the first terminal uploads the attribute information to the server, and the server stores the attribute information of the target virtual object. When the target virtual object re-joins another virtual scene, the server can synchronize the attribute information of the target virtual object to another terminal associated with the virtual scene. In this case, the attribute information of the target virtual object serves as initial information for the target virtual object to join the virtual scene. The first terminal controls the target virtual object to exit the virtual scene, and the first terminal does not display the virtual scene.

417: The second terminal removes the target virtual object from the virtual scene.

In aspects of this application, the second terminal removes the target virtual object from the virtual scene, and the second terminal still displays the virtual scene.

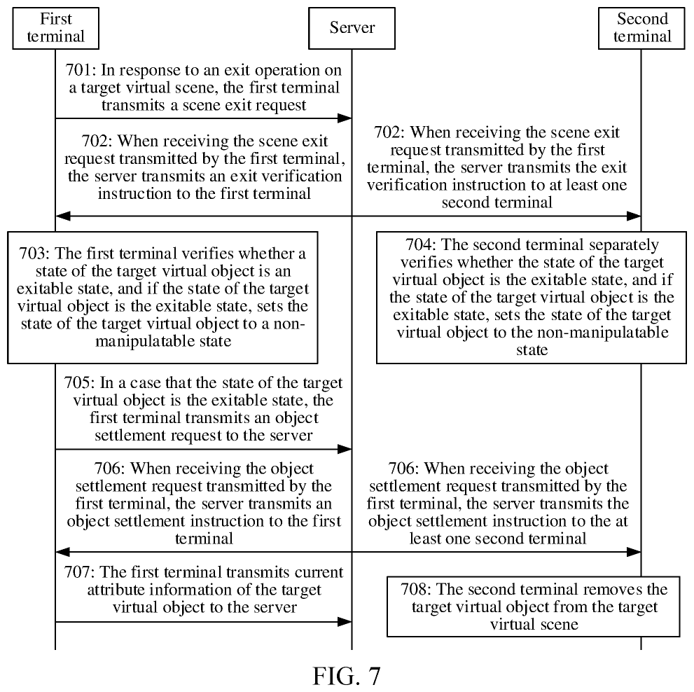

To more clearly describe a process in which the target virtual object exits the virtual scene, the process is further described below with reference to the accompanying drawings. FIG. 7 is a flowchart of an interaction of a target virtual object exiting a virtual scene according to an aspect of this application. Refer to FIG. 7. The process in which the target virtual object requests to exit the virtual scene may be implemented by the following operation 701 to operation 708. 701: In response to an exit operation on the virtual scene, a first terminal transmits a scene exit request. 702: When receiving the scene exit request transmitted by the first terminal, a server transmits an exit verification instruction to the first terminal and at least one second terminal. 703: The first terminal verifies whether a state of the target virtual object is an exitable state, and if the state of the target virtual object is the exitable state, sets the state of the target virtual object to a non-manipulatable state. 704: The second terminal verifies whether a state of the target virtual object is an exitable state, and if the state of the target virtual object is the exitable state, sets the state of the target virtual object to a non-manipulatable state. 705: In a case that the state of the target virtual object is the exitable state, the first terminal transmits an object settlement request to the server. 706: When receiving the object settlement request transmitted by the first terminal, the server transmits an object settlement instruction to the first terminal and the at least one second terminal. 707: The first terminal transmits current attribute information of the target virtual object to the server. 708: The second terminal removes the target virtual object from the virtual scene. In this case, the target virtual object formally exits the virtual scene.

An aspect of this application provides a virtual scene synchronization solution. When a target virtual object controlled by a first terminal requests to join a virtual scene, data of a scene image frame is returned to the first terminal in a process in which scene progress of the virtual scene is run from initial progress to target progress, so that the first terminal can perform fast frame chasing based on the obtained data. In this way, the first terminal can run the scene progress of the virtual scene from the initial progress to the target progress. When the virtual scene of the first terminal is run to the target progress, an object loading instruction carrying an object identifier is transmitted to the first terminal and at least one terminal at which a virtual object in the virtual scene is located, so that each terminal can load the target virtual object in the virtual scene at the target progress. This realizes synchronous display of the virtual scene on each terminal, makes an occasion for the target virtual object to join the virtual scene unrestricted, ensures consistency of displaying the virtual scene on each terminal no matter when the virtual object requests to join the virtual scene, and improves flexibility of participating in the virtual scene.

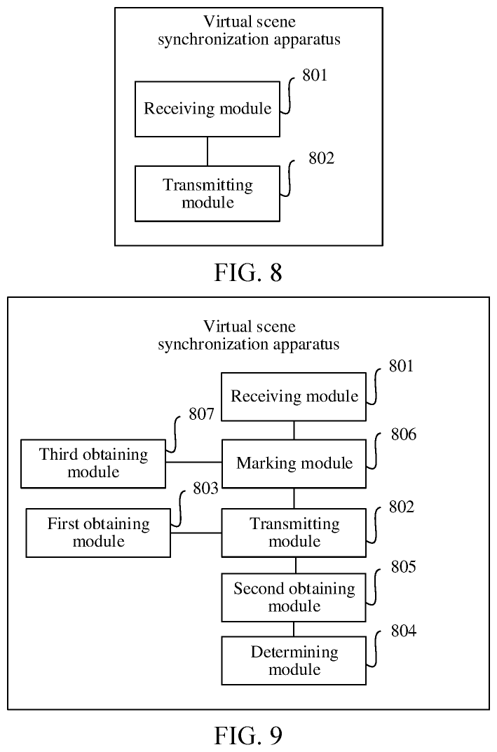

FIG. 8 is a schematic diagram of a structure of a virtual scene synchronization apparatus according to an aspect of this application. The apparatus is configured to perform the operations performed when the virtual scene synchronization method described above is performed. Refer to FIG. 8. The virtual scene synchronization apparatus includes: a receiving module 801 and a transmitting module 802.

The receiving module 801 is configured to receive a midway joining request that is for a virtual scene and that is transmitted by a first terminal, where the midway joining request carries an object identifier of a target virtual object, the target virtual object is a virtual object controlled by the first terminal, and the virtual scene includes a virtual object controlled by at least one second terminal.

The transmitting module 802 is configured to transmit data of a plurality of scene image frames of the virtual scene to the first terminal, where the data of the plurality of scene image frames is used to run scene progress of the virtual scene from initial progress to target progress, and the target progress is scene progress at which the virtual scene is currently located.

The transmitting module 802 is further configured to: in response to the first terminal running the scene progress of the virtual scene to the target progress, transmit an object loading instruction carrying the object identifier to the first terminal and the at least one second terminal to enable the first terminal and the at least one second terminal to load the target virtual object in the virtual scene.

In some aspects, FIG. 9 is a schematic diagram of a structure of another virtual scene synchronization apparatus according to an aspect of this application. Refer to FIG. 9. The transmitting module 802 is configured to: obtain data of a plurality of scene image frames of a virtual scene, where the data of the scene image frames includes a first type of data, and the first type of data is used to perform operation logic; and transmit the first type of data of the plurality of scene image frames to a first terminal.

In some aspects, with continued reference to FIG. 9, the data of the scene image frames further includes a second type of data, and the second type of data is used to perform rendering logic. The apparatus further includes:
a first obtaining module 803, configured to obtain a plurality of target scene image frames in a target frame quantity range from the plurality of scene image frames.

The transmitting module 802 is further configured to transmit the second type of data of the plurality of target scene image frames to the first terminal.

In some aspects, with continued reference to FIG. 9, the data of the scene image frames further includes a second type of data, and the second type of data is used to perform rendering logic. The apparatus further includes:
a determining module 804, configured to determine a plurality of pieces of rendering content based on the data of the plurality of scene image frames; and
a second obtaining module 805, configured to obtain, from the data of the plurality of scene image frames, data of target rendering content, where a rendering priority of the target rendering content is higher than a target priority, and the data of the target rendering content is partial data of a second type of data of a scene image frame in which the target rendering content is located.

The transmitting module 802 is further configured to transmit the data of the target rendering content to the first terminal.

In some aspects, with continued reference to FIG. 9, the transmitting module 802 is further configured to: in response to object control requests transmitted by the first terminal and at least one second terminal, transmit a control confirmation instruction to the first terminal and the at least one second terminal, where the control confirmation instruction indicates to switch the target virtual object to a controllable state.

In some aspects, with continued reference to FIG. 9, the receiving module 801 is further configured to receive a scene exit request that is for the virtual scene and that is transmitted by the first terminal, where the scene exit request carries the object identifier of the target virtual object.

The transmitting module 802 is further configured to transmit an exit verification instruction to the first terminal, where the exit verification instruction indicates to determine whether a state of the target virtual object is an exitable state.

The transmitting module 802 is further configured to: in response to an object settlement request transmitted by the first terminal, transmit an object settlement instruction to the first terminal and the at least one first terminal, where the object settlement instruction indicates the first terminal to report current attribute information of the target virtual object, and indicates the at least one second terminal to remove the target virtual object from the virtual scene.

In some aspects, with continued reference to FIG. 9, the apparatus further includes:
a marking module 806, configured to: mark any first virtual object in the virtual scene with a first marker, where the first virtual object is a virtual object present when the scene progress of the virtual scene is the initial progress, and the first marker indicates that the first virtual object is always present in the virtual scene.

In some aspects, with continued reference to FIG. 9, the marking module 806 is further configured to: in response to a midway joining request, modify the first marker of the target virtual object to a second marker in a case that the target virtual object is the first virtual object, where the second marker indicates that the target virtual object exited the virtual scene and joins the virtual scene this time.

The marking module 806 is further configured to: in a case that the target virtual object is not the first virtual object, mark the target virtual object with a third marker, where the third marker indicates that the target virtual object joins the virtual scene this time.

In some aspects, with continued reference to FIG. 9, the apparatus further includes:
a third obtaining module 807, configured to: in response to the midway joining request, obtain a marker of at least one second virtual object that was present in the virtual scene, where the marker of the second virtual object is the first marker, the second marker, or the third marker.

The marking module 806 is further configured to: in a case that a marker of any second virtual object is the second marker, modify the second marker of the second virtual object to a fourth marker, where the fourth marker indicates that the second virtual object does not join the virtual scene this time.

The marking module 806 is further configured to: in a case that the marker of the second virtual object is the third marker, modify the third marker of the second virtual object to a fifth marker, where the fifth marker indicates that the second virtual object does not join the virtual scene this time.

An aspect of this application provides a virtual scene synchronization apparatus. When a target virtual object controlled by a first terminal requests to join a virtual scene, data of a scene image frame is returned to the first terminal in a process in which scene progress of the virtual scene is run from initial progress to target progress, so that the first terminal can perform fast frame chasing based on the obtained data. In this way, the first terminal can run the scene progress of the virtual scene from the initial progress to the target progress. When the virtual scene of the first terminal is run to the target progress, an object loading instruction carrying an object identifier is transmitted to the first terminal and at least one terminal at which a virtual object in the virtual scene is located, so that each terminal can load the target virtual object in the virtual scene at the target progress. This realizes synchronous display of the virtual scene on each terminal, makes an occasion for the target virtual object to join the virtual scene unrestricted, ensures consistency of displaying the virtual scene on each terminal no matter when the virtual object requests to join the virtual scene, and improves flexibility of participating in the virtual scene.

When running an application, the virtual scene synchronization apparatus provided by the above aspects only describes division into the above function modules as an example, and in practice, the above functions may be distributed to be performed by different function modules as needed. In other words, an internal structure of the server is divided into different function modules to perform all or part of the functions described above. In addition, the virtual scene synchronization apparatus provided by the above aspects belongs to the same concept as the virtual scene synchronization method aspects, and an implementation process is shown in the method aspects. Details are not described in detail herein again.

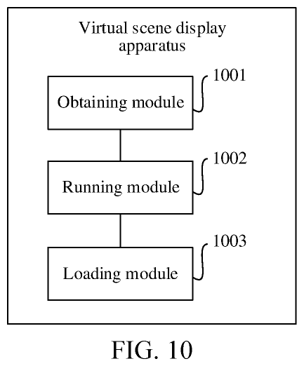

FIG. 10 is a schematic diagram of a structure of a virtual scene display apparatus according to an aspect of this application. The apparatus is configured to perform the operations performed when the virtual scene display method described above is performed. Refer to FIG. 10. The virtual scene display apparatus includes: an obtaining module 1001, a running module 1002, and a loading module 1003.

The obtaining module 1001 is configured to obtain data of a plurality of scene image frames of a virtual scene in response to a midway joining operation on the virtual scene, where the midway joining operation indicates to join a target virtual object to the virtual scene.

The running module 1002 is configured to run, based on the data of the plurality of scene image frames, the scene progress of the virtual scene from the initial progress to the target progress, where the target progress is scene progress at which the virtual scene is currently located.

The loading module 1003 is configured to load the target virtual object in the virtual scene.

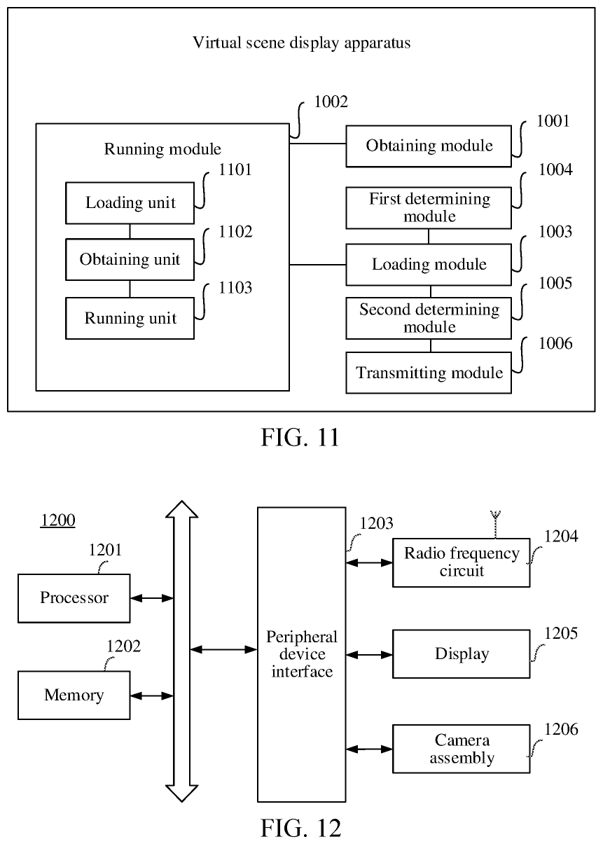

In some aspects, FIG. 11 is a schematic diagram of a structure of another virtual scene display apparatus according to an aspect of this application. Refer to FIG. 11. Data of a scene image frame includes a first type of data. The first type of data is used to perform operation logic.

The running module 1002 includes:
a loading unit 1101, configured to load a virtual scene obtained when scene progress is initial progress;
an obtaining unit 1102, configured to obtain a first type of data of a plurality of scene image frames from data of the plurality of scene image frames; and
a running unit 1103, configured to run the scene progress of the virtual scene from the initial progress to a target progress based on the first type of data of the plurality of scene image frames.

In some aspects, with continued reference to FIG. 11, the data of the scene image frames further includes a second type of data, where the second type of data is used to perform rendering logic. The running unit 1103 is configured to: obtain a plurality of target scene image frames in a target frame quantity range from the plurality of scene image frames; obtain a second type of data of the plurality of target scene image frames; and run, based on the second type of data of the plurality of target scene image frames and the first type of data of the plurality of scene image frames, the scene progress of the virtual scene from the initial progress to the target progress.

In some aspects, with continued reference to FIG. 11, the data of the scene image frames further includes a second type of data, where the second type of data is used to perform rendering logic. The running unit 1103 is configured to: determine a plurality of pieces of rendering content based on the data of the plurality of scene image frames; obtain, from the data of the plurality of scene image frames, data of target rendering content, where a rendering priority of the target rendering content is higher than a target priority, and the data of the target rendering content is partial data of a second type of data of a scene image frame in which the target rendering content is located; and run, based on the data of the target rendering content and the first type of data of the plurality of scene image frames, the scene progress of the virtual scene from the initial progress to the target progress

In some aspects, with continued reference to FIG. 11, the apparatus further includes:
a first determining module 1004, configured to determine, based on the data of the plurality of scene image frames, a marker of at least one virtual object associated with the virtual scene.

The loading module 1003 is further configured to load, in the virtual scene of which the scene progress is the initial progress in a case that a target marker exists, a virtual object having the target marker, where the target marker indicates that the virtual object exists when the scene progress of the virtual scene is the initial progress.

In some aspects, with continued reference to FIG. 11, the running module 1002 is configured to: display the virtual scene obtained when the scene progress is the initial progress; divide the data of the plurality of scene image frames in time sequence into a first frame data group and a second frame data group; render the virtual scene in a partially rendering manner based on the first frame data group; and render the virtual scene in a fully rendering manner based on the second frame data group, such that the virtual scene is loaded to the target progress.

In some aspects, with continued reference to FIG. 11, the loading module 1003 is configured to preload the target virtual object in the virtual scene before the scene progress of the virtual scene is loaded to the target progress.

In some aspects, with continued reference to FIG. 11, the apparatus further includes:
a second determining module 1005, configured to determine a state of the target virtual object in response to an exit operation on the virtual scene; and
a sending module 1006, configured to send, to a server, current attribute information of the target virtual object in a case that the state of the target virtual object is an exitable state.

An aspect of this application provides a virtual scene display apparatus. When a target virtual object controlled by a first terminal requests to join a virtual scene, data of a scene image frame obtained in a process in which scene progress of the virtual scene is run from initial progress to target progress is obtained, so that the first terminal can perform fast frame chasing based on the obtained data, to run the scene progress of the virtual scene from the initial progress to the target progress, and then, to load the target virtual object in the virtual scene. In this way, the scene progress of the virtual scene displayed by the first terminal is synchronized with scene progress of the virtual scene displayed by another terminal. This makes an occasion for the target virtual object to join the virtual scene unrestricted, ensures consistency of displaying the virtual scene on each terminal no matter when the virtual object requests to join the virtual scene, and improves flexibility of participating in the virtual scene.

When running an application, the virtual scene display apparatus provided by the above aspects only describes division into the above function modules as an example, and in practice, the above functions may be distributed to be performed by different function modules as needed. In other words, an internal structure of the first terminal is divided into different function modules to perform all or part of the functions described above. In addition, the virtual scene display apparatus provided by the above aspects belongs to the same concept as the virtual scene display method aspects, and an implementation process is shown in the method aspects. Details are not described in detail herein again.

In aspects of this application, the computer device can be configured as a terminal or a server. When the computer device is configured as a terminal, the technical solutions provided by the aspects of this application may be implemented by the terminal as an execution subject. When the computer device is configured as a server, the technical solutions provided by the aspects of this application may be implemented by the server as an execution subject, or the technical solutions provided by this application may be implemented by interaction between the terminal and the server. This is not specifically limited in aspects of this application.

FIG. 12 is a schematic diagram of a structure of a terminal 1200 according to an aspect of this application. The terminal 1200 may be a portable mobile terminal, for example, a smartphone, a tablet computer, a Moving Picture Experts Group Audio Layer III (MP3) player, an Moving Picture Experts Group Audio Layer IV (MP4) player, a laptop computer, or a desktop computer. The terminal 1200 may also be referred to as another name, for example, user equipment, a portable terminal, a laptop terminal, or a desktop terminal.

Generally, the terminal 1200 includes a processor 1201 and a memory 1202.

The processor 1201 may include one or more processing cores, such as a 4-core processor or an 8-core processor. The processor 1201 may be implemented in a hardware form of at least one of digital signal processing (DSP), a field-programmable gate array (FPGA), a programmable logic array (PLA). The processor 1201 may further include a main processor and a co-processor. The main processor is a processor for processing data in a wake-up state, which is also referred to as a central processing unit (CPU). The co-processor is a low power processor for processing data in a standby state. In some aspects, the processor 1201 may be integrated with a graphics processing unit (GPU). The GPU is responsible for taking care of rendering and drawing of content that needs to be displayed on a display. In some aspects, the processor 1201 may further include an artificial intelligence (AI) processor. The processor is configured to process computational operations related to machine learning.

The memory 1202 may include one or more computer-readable storage media. The computer-readable storage medium may be non-transitory. The memory 1202 may further include a high-speed random access memory as well as a non-volatile memory, for example, one or more magnetic disk storage devices or flash storage devices. In some aspects, the non-transitory computer-readable storage medium in the memory 1202 is configured to store at least one computer program. The at least one computer program is configured to be executed by the processor 1201 to implement the virtual scene synchronization method or the virtual scene display method provided by the method aspects in this application.

In some aspects, the terminal 1200 further includes a peripheral device interface 1203 and at least one peripheral device. The processor 1201, the memory 1202, and the peripheral device interface 1203 may be connected through a bus or a signal line. The peripheral devices may be connected to the peripheral device interface 1203 through a bus, a signal line, or a circuit board. Specifically, the peripheral device includes at least one of a radio frequency circuit 1204, a display 1205, or a camera assembly 1206.

The peripheral device interface 1203 may be configured to connect at least one Input/Output (I/O)-related peripheral device to the processor 1201 and the memory 1202. In some aspects, the processor 1201, the memory 1202, and the peripheral device interface 1203 are integrated onto a same chip or circuit board. In some other aspects, any one or two of the processor 1201, the memory 1202, and the peripheral device interface 1203 may be implemented on a separate chip or circuit board. This is not limited in this application.

The radio frequency circuit 1204 is configured to receive and transmit a radio frequency (RF) signal, which is also referred to as an electromagnetic signal. The radio frequency circuit 1204 communicates with a communication network and another communication device based on an electromagnetic signal. The radio frequency circuit 1204 converts an electrical signal to an electromagnetic signal for transmission, or converts a received electromagnetic signal to an electrical signal. In some aspects, the radio frequency circuit 1204 includes an antenna system, an RF transceiver, one or more amplifiers, a tuner, an oscillator, a digital signal processor, a codec chipset, a subscriber identity module card, and the like. The radio frequency circuit 1204 may communicate with another terminal according to at least one wireless communication protocol. The wireless communication protocol includes, but is not limited to, the World Wide Web, a metropolitan area network, an intranet, various generations of mobile communication networks (2G, 3G, 4G, and 5G), a wireless local area network, and/or a Wireless Fidelity (Wi-Fi) network. In some aspects, the radio frequency circuit 1204 may further include a near field communication (NFC)-related circuit. This is not limited in this application.

The display 1205 is configured to display a user interface (UI). The UI may include a graph, a text, an icon, a video, and any combination thereof. When the display 1205 is a touch display, the display 1205 also has an ability to collect a touch signal at or above a surface of the display 1205. The touch signal may be input to the processor 1201 as a control signal for processing. In this case, the display 1205 may further be configured to provide a virtual button and/or a virtual keyboard, which is also referred to as a soft button and/or a soft keyboard. In some aspects, there may be one display 1205, disposed on a front panel of the terminal 1200. In some other aspects, there may be at least two displays 1205, each of which is disposed on a different surface of the terminal 1200 or in a folded design, In some other aspects, the display 1205 may be a flexible display disposed on a curved surface or on a folded surface of the terminal 1200. Even further, the display 1205 may be arranged in a non-rectangular irregular pattern, i.e., a contoured screen. The display 1205 can be manufactured by using a liquid crystal display (LCD), an organic light-emitting diode (OLED), or the like.

The camera assembly 1206 is configured to capture an image or a video. In some aspects, the camera assembly 1206 includes a front-facing camera and a rear-facing camera. Generally, the front-facing camera is disposed on the front panel of the terminal, and the rear-facing camera is disposed on a back surface of the terminal. In some aspects, there are at least two rear-facing cameras, each of which is any of a main camera, a depth-of-field camera, a wide angle camera, and a telephoto camera, to achieve a background blurring function implemented through fusion of the main camera and the depth-of-field camera, panoramic image shooting and virtual reality (VR) image shooting functions implemented through fusion of the main camera and the wide angle camera, or another fusion image shooting function. In some aspects, the camera assembly 1206 may further include a flash light. The flash light may be a monochrome temperature flash light, or may be a dual-color temperature flash light. The dual color temperature flash light indicates a combination of a warm light flash light and a cold light flash light, and may be configured for light compensation under different color temperatures.

A person skilled in the art will appreciate that the structure shown in FIG. 12 does not constitute a limitation of the terminal 1200. More or fewer components than illustrated may be included, or some components may be combined, or different arrangements of components may be employed.

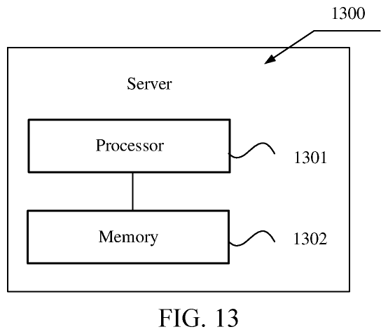

FIG. 13 is a schematic diagram of a structure of a server according to an aspect of this application. The server 1300 may vary significantly due to configuration or performance differences, and may include one or more central processing units (CPUs) 1301 and one or more memories 1302. At least one segment of computer program is stored in the memory 1302, and the at least one segment of computer program is loaded and executed by the processor 1301 to implement the virtual scene synchronization method or the virtual scene display method provided by the above method aspects. Certainly, the server may further have components such as a wired or wireless network interface, a keyboard, input and output interfaces for input and output. The server may further include another component for implementing a device function. Details are not described in detail herein again.

An aspect of this application further provides a computer-readable storage medium having at least one segment of computer program stored therein. The at least one segment of computer program is loaded and executed by a processor of a computer device to implement the virtual scene synchronization method or the virtual scene display method of the above aspects. For example, the computer-readable storage medium is a read-only memory (ROM), a random access memory (RAM), a compact disc read-only memory (CD-ROM), a magnetic tape, a floppy disk, an optical data storage device, and the like.

An aspect of this application further provides a computer program product. When performed by a processor, the computer program product implements the virtual scene synchronization method in aspects of this application, or when performed by a processor, the computer program product implements the virtual scene display method in aspects of this application.

It will be appreciated by a person skilled in the art that all or some of the operations for implementing the above-described aspects may be performed by hardware, or by using a program indicating relevant hardware. The program may be stored in a computer-readable storage medium. The above-mentioned storage medium may be a read-only memory, a magnetic or optical disk, or the like.

The foregoing descriptions are merely optional aspects of this application, but are not intended to limit this application. Any modification, equivalent replacement, improvement, or the like made within the spirit and principle of this application shall fall within the protection scope of this application.

What is claimed is:

1. A virtual scene synchronization method, the method comprising:
receiving, by a server, a midway joining request that is for a virtual scene and that is transmitted by a first terminal, the midway joining request carrying an object identifier of a target virtual object, the target virtual object being a virtual object controlled by the first terminal, and the virtual scene comprising a virtual object controlled by at least one second terminal;
transmitting, by the server, data of a plurality of scene image frames of the virtual scene to the first terminal, the data of the plurality of scene image frames being used to run scene progress of the virtual scene from an initial progress state to a target progress state at which the virtual scene is currently located; and
in response to the first terminal running the scene progress of the virtual scene to the target progress state, transmitting, by the server, an object loading instruction carrying the object identifier to the first terminal and the at least one second terminal to enable the first terminal and the at least one second terminal to load the target virtual object in the virtual scene.

2. The method according to claim 1, wherein the transmitting, by the server, data of the plurality of scene image frames of the virtual scene to the first terminal comprises:
obtaining, by the server, the data of the plurality of scene image frames, wherein the data of the scene image frames comprises a first type of data usable by first terminal to perform operation logic; and
transmitting, by the server, the first type of data of the plurality of scene image frames to the first terminal.

3. The method according to claim 2, wherein the data of the scene image frames further comprises a second type of data usable to perform rendering logic; and the transmitting, by the server, data of a plurality of scene image frames of the virtual scene to the first terminal comprises:
obtaining, by the server, a plurality of target scene image frames in a target frame quantity range from the plurality of scene image frames; and
transmitting, by the server, the second type of data of the plurality of target scene image frames to the first terminal.

4. The method according to claim 2, wherein the data of the scene image frames further comprises a second type of data usable to perform rendering logic; and the method comprises:
determining, by the server, a plurality of pieces of rendering content based on the data of the plurality of scene image frames;
obtaining, by the server, from the data of the plurality of scene image frames, data of target rendering content, wherein a rendering priority of the target rendering content is higher than a target priority, and the data of the target rendering content is partial data of a second type of data of a scene image frame in which the target rendering content is located; and
transmitting, by the server, the data of the target rendering content to the first terminal.

5. The method according to claim 1, wherein the method further comprises:
receiving, by the server and from the first terminal, a scene exit request that is for the virtual scene, wherein the scene exit request carries the object identifier of the target virtual object;
transmitting, by the server to the first terminal, an exit verification instruction, wherein the exit verification instruction indicates to determine whether a state of the target virtual object is an exitable state; and
in response to receiving an object settlement request originating from the first terminal, transmitting, by the server, an object settlement instruction to the first terminal and the at least one second terminal, wherein the object settlement instruction indicates the first terminal to report current attribute information of the target virtual object, and indicates the at least one second terminal to remove the target virtual object from the virtual scene.

6. The method according to claim 1, wherein the method further comprises:
marking, by the server, any first virtual object in the virtual scene with a first marker, wherein the first virtual object is a virtual object present when the scene progress of the virtual scene is the initial progress state, and the first marker indicates that the first virtual object is always present in the virtual scene.

7. The method according to claim 6, wherein the method further comprises:
in response to the midway joining request, modifying, by the server, the first marker of the target virtual object to a second marker in a case that the target virtual object is the first virtual object, wherein the second marker indicates that the target virtual object exited the virtual scene and joins the virtual scene this time; and
in a case that the target virtual object is not the first virtual object, marking, by the server, the target virtual object with a third marker, wherein the third marker indicates that the target virtual object joins the virtual scene this time.

8. The method according to claim 7, wherein the method further comprises:
in response to the midway joining request, obtaining, by the server, a marker of at least one second virtual object that was present in the virtual scene, wherein the marker of the second virtual object id either the first marker, the second marker, or the third marker;
when a marker of any second virtual object is the second marker, modifying, by the server, the second marker of the second virtual object to a fourth marker, wherein the fourth marker indicates that the second virtual object does not join the virtual scene this time; and
when the marker of the second virtual object is the third marker, modifying, by the server, the third marker of the second virtual object to a fifth marker, wherein the fifth marker indicates that the second virtual object does not join the virtual scene this time.

9. The method according to claim 1, wherein the method further comprises:
in response to object control requests transmitted by the first terminal and the at least one second terminal, transmitting, by the server to the first terminal and at least one second terminal, a control confirmation instruction, wherein the control confirmation instruction indicates to switch the target virtual object to a controllable state.

10. A virtual scene display method, the method comprising:
obtaining, by a first terminal, data of a plurality of scene image frames of a virtual scene in response to a midway joining operation on the virtual scene, the midway joining operation indicating to join a target virtual object to the virtual scene;
running, by the first terminal based on the data of the plurality of scene image frames, scene progress of the virtual scene from initial progress state to a target progress state, the target progress state being scene progress at which the virtual scene is currently located; and
loading, by the first terminal, the target virtual object in the virtual scene.

11. The method according to claim 10, wherein the data of the scene image frames comprises a first type of data, and the first type of data is used to perform operation logic; and
the running, by the first terminal based on the data of the plurality of scene image frames, scene progress of the virtual scene from the initial progress state to the target progress state comprises:
loading, by the first terminal, the virtual scene obtained when the scene progress is the initial progress state;
obtaining, by the first terminal, the first type of data of the plurality of scene image frames from the data of the plurality of scene image frames; and
running, by the first terminal based on the first type of data of the plurality of scene image frames, the scene progress of the virtual scene from the initial progress state to the target progress state.

12. The method according to claim 11, wherein the data of the scene image frames further comprises a second type of data, and the second type of data is used to perform rendering logic;
and the running, by the first terminal based on the first type of data of the plurality of scene image frames, the scene progress of the virtual scene from the initial progress state to the target progress state comprises:
obtaining, by the first terminal, a plurality of target scene image frames in a target frame quantity range from the plurality of scene image frames;
obtaining, by the first terminal, a second type of data of the plurality of target scene image frames; and
running, by the first terminal based on the second type of data of the plurality of target scene image frames and the first type of data of the plurality of scene image frames, the scene progress of the virtual scene from the initial progress state to the target progress state.

13. The method according to claim 11, wherein the data of the scene image frames further comprises a second type of data, and the second type of data is used to perform rendering logic; and the running, by the first terminal based on the first type of data of the plurality of scene image frames, the scene progress of the virtual scene from the initial progress state to the target progress state comprises:
determining, by the first terminal, a plurality of pieces of rendering content based on the data of the plurality of scene image frames;
obtaining, by the first terminal, from the data of the plurality of scene image frames, data of target rendering content, wherein a rendering priority of the target rendering content is higher than a target priority, and the data of the target rendering content is partial data of a second type of data of a scene image frame in which the target rendering content is located; and
running, by the first terminal based on the data of the target rendering content and the first type of data of the plurality of scene image frames, the scene progress of the virtual scene from the initial progress state to the target state progress.

14. The method according to claim 10, wherein the method further comprises:
determining, by the first terminal based on the data of the plurality of scene image frames, a marker of at least one virtual object associated with the virtual scene; and
loading, by the first terminal in the virtual scene of which the scene progress is the initial progress state in a case that a target marker exists, a virtual object having the target marker, wherein the target marker indicates that the virtual object exists when the scene progress of the virtual scene is the initial progress state.

15. The method according to claim 10, wherein the running, by the first terminal based on the data of the plurality of scene image frames, scene progress of the virtual scene from initial progress state to target progress state comprises:
outputting for display, by the first terminal, the virtual scene obtained when the scene progress is the initial progress state;
dividing, by the first terminal, the data of the plurality of scene image frames in time sequence into a first frame data group and a second frame data group;
rendering, by the first terminal, the virtual scene in a partially rendering manner based on the first frame data group; and
rendering, by the first terminal, the virtual scene in a fully rendering manner based on the second frame data group, such that the virtual scene is loaded to the target progress state.

16. The method according to claim 10, wherein the method further comprises:
determining, by the first terminal, a state of the target virtual object in response to an exit operation on the virtual scene; and
transmitting, by the first terminal to a server, current attribute information of the target virtual object in a case that the state of the target virtual object is an exitable state.

17. The method according to claim 10, wherein the loading, by the first terminal, the target virtual object in the virtual scene comprises:
preloading, by the first terminal, the target virtual object in the virtual scene before the scene progress of the virtual scene is loaded to the target progress state.

18. One or more non-transitory computer readable media storing computer readable instructions which, when executed by a processor, configure a data processing system to perform:
receiving a midway joining request that is for a virtual scene and that is transmitted by a first terminal, the midway joining request carrying an object identifier of a target virtual object, the target virtual object being a virtual object controlled by the first terminal, and the virtual scene comprising a second virtual object controlled by at least one second terminal;
transmitting data of a plurality of scene image frames of the virtual scene to the first terminal, the data of the plurality of scene image frames being used to run scene progress of the virtual scene from an initial progress state to a target progress state at which the virtual scene is currently located; and
in response to the first terminal running the scene progress of the virtual scene to the target progress state, transmitting an object loading instruction carrying the object identifier to the first terminal and the at least one second terminal to enable the first terminal and the at least one second terminal to load the target virtual object in the virtual scene.

19. The computer readable media of claim 18, wherein the transmitting data of the plurality of scene image frames of the virtual scene to the first terminal comprises:
obtaining the data of the plurality of scene image frames, wherein the data of the scene image frames comprises a first type of data usable by first terminal to perform operation logic; and
transmitting the first type of data of the plurality of scene image frames to the first terminal, and
wherein the data of the scene image frames further comprises a second type of data usable to perform rendering logic, and the transmitting data of the plurality of scene image frames of the virtual scene to the first terminal comprises:
obtaining a plurality of target scene image frames in a target frame quantity range from the plurality of scene image frames; and
transmitting the second type of data of the plurality of target scene image frames to the first terminal.

20. One or more non-transitory computer readable media storing computer readable instructions which, when executed by a processor, configure a data processing system to perform:
obtaining data of a plurality of scene image frames of a virtual scene in response to a midway joining operation on the virtual scene, the midway joining operation indicating to join a target virtual object to the virtual scene;
running, based on the data of the plurality of scene image frames, scene progress of the virtual scene from an initial progress state to a target progress state, the target progress state being scene progress at which the virtual scene is currently located; and
loading the target virtual object in the virtual scene.
